(19) United States
(12) Patent Application Publication
(10) Pub. No.: US 2008/0289469 A1
(43) Pub. Date: Nov. 27, 2008

(54) Sawing angle sensing device for a sawing machine

(76) Inventor: Bor-Yann Chuang, Taichung (TW)

Correspondence Address: BACON & THOMAS, PLLC, 625 SLATERS LANE, FOURTH FLOOR, ALEXANDRIA, VA, 22314-1176, US

(21) Appl. No.: 11/802,619

(22) Filed: May 24, 2007

(51) Int. Cl. B23D 47/04

(52) U.S. Cl. 83/473

(57) ABSTRACT

A sawing angle sensing device for a sawing machine includes at least a support frame, a sensing head, an induction plate and a display module. The support frame has one side secured on the rotatable base of a sawing machine for rotating and swinging together with the rotatable base. The sensing head is fixed at the other side of the support frame and actuated to swing by the support frame. The induction plate is disposed at a corresponding location of the sensing head, having its surface provided with a successive signal set made of plural induction members. Thus, the sensing head can always correspond to the induction members and sense the shifting signals of the induction members. The display module is provided with a microchip set to receive signals and collate the signals and then output an angle tilt signal to be shown on a digital display.

### BACKGROUND OF THE INVENTION

1. Field of the Invention

This invention relates to a sawing angle sensing device for a sawing machine, particularly to one able to accurately measure the sawing angle and indicate deflection of the sawing angle of a saw base and also able to correct the sawing angle anew.

2. Description of the Prior Art

A conventional sawing machine 10 for cutting wood to form a smooth and slanting cutting surface, as shown in FIG. 1, includes a saw base 11 and a driving link 12 combined together. The driving link 12 can be turned to actuate the saw base 11 to rotate for an angle, and the sawing machine 10 is provided with an angle indication plate 13 at a preset location for indicating the rotating angle of the saw base 11.

However, the angle indication plate 13 of the conventional sawing machine 10 indicates the rotating angle of the saw base 11 in a way of graduations, which can hardly indicate the rotating angle with great precision; therefore, the rotating angle of the saw base 11, measured by the indication plate 13, is only an approximate numerical value, and the angle data obtained by viewing with eyes may produce deviation, thus disabling the angle indication plate 13 to carry out measuring with accuracy. In addition, the transmission of motion between the driving link 12 and the saw base 11 is carried out by gears, which may be worn off and produce backlash after being used for a period of time; therefore, the rotation angle of the conventional sawing machine 10 may produce deviation and such deviation cannot be shown on the angle indication plate 13, thus impossible to elevate processing accuracy and likely to lower processing quality.

### SUMMARY OF THE INVENTION

The objective of this invention is to offer a sawing angle sensing device for a sawing machine, including at least a support frame, a sensing head, an induction plate and a display module combined together. The support frame has one side secured with the rotatable base of a sawing machine for rotating together with the rotatable base. The sensing head is fixed at the other side of the support frame, actuated to swing by the support frame. The induction plate is disposed at a corresponding location of the sensing head, having its surface provided thereon with a successive signal set made of plural induction members. The induction members of the signal set are arranged in sequence with the swinging path of the sensing head so that the sensing head can correspond to the induction member and sense the shifting signals of the induction members. The display module is composed of at least a microchip set and a digital display. The micro-chip set is able to receive the signal input by the sensing head and have the signal collated and then output an angle tilt signal to be shown on the digital display. Thus, when the rotatable base is turned to actuate the saw base to rotate for an angle, the rotating angle of the saw base can precisely be shown on the digital display of the display module, able to avoid errors caused by viewing with eyes. In addition, the display module is provided with a set switch for resetting the measuring value of the angle sensing device to enable the angle sensing device to correct the measuring value anew, letting the angle of the saw base able to be read accurately to enhance processing accuracy.

### BRIEF DESCRIPTION OF DRAWINGS

This invention will be better understood by referring to the accompanying drawings, wherein:

FIG. 1 is a side sectional view of a conventional sawing machine;

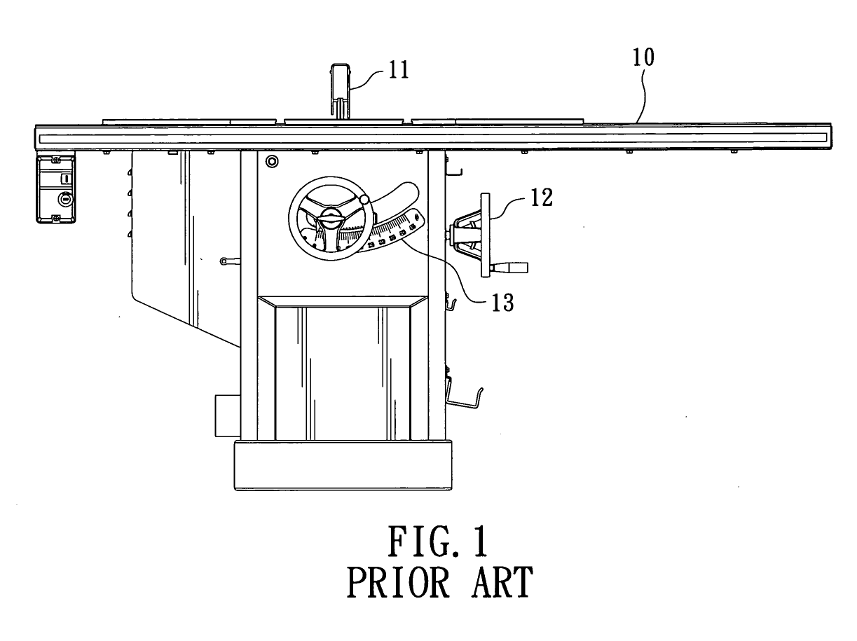

FIG. 2 is a side sectional view of a first preferred embodiment of a sawing angle sensing device for a sawing machine in the present invention;

FIG. 3 is a side cross-sectional view of the first preferred embodiment of the sawing angle sensing device for a sawing machine in the present invention;

FIG. 4 is an exploded perspective view of the first preferred embodiment of the sawing angle sensing device for a sawing machine in the present invention;

FIG. 5 is a side cross-sectional view of the first preferred embodiment of the sawing angle sensing device for a sawing machine in an operating condition in the present invention;

FIG. 6 is a partial perspective view of the first preferred embodiment of the sawing angle sensing device for a sawing machine in an operating condition in the present invention;

FIG. 7 is a side cross-sectional view of the first preferred embodiment of the sawing angle sensing device for sawing machine in another operating condition in the present invention in the present invention;

FIG. 8 is a side sectional view of a second preferred embodiment of a sawing angle sensing device for a sawing machine in the present invention; and

FIG. 9 is a side sectional view of a third preferred embodiment of a sawing angle sensing device for a sawing machine in the present invention.

### DETAILED DESCRIPTION OF THE PREFERRED EMBODIMENT

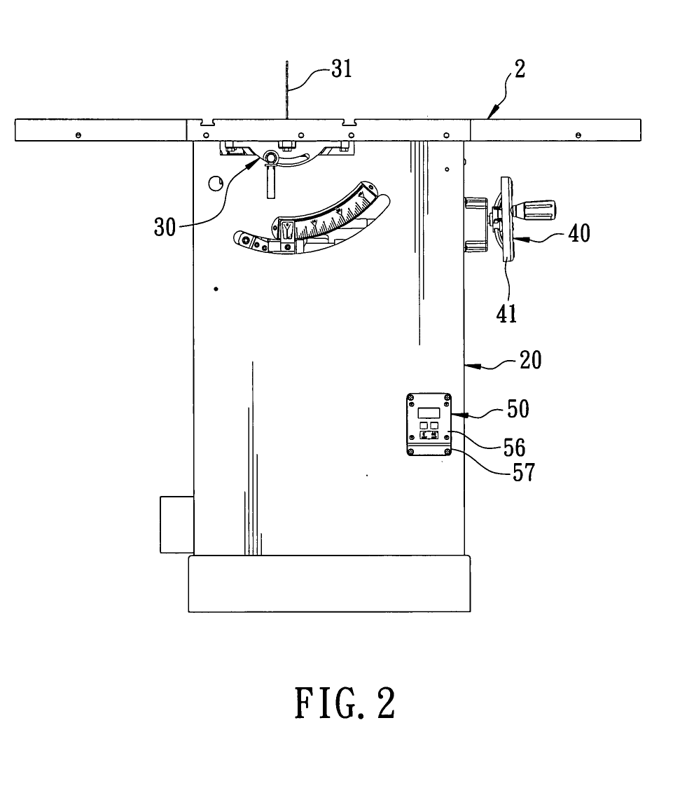

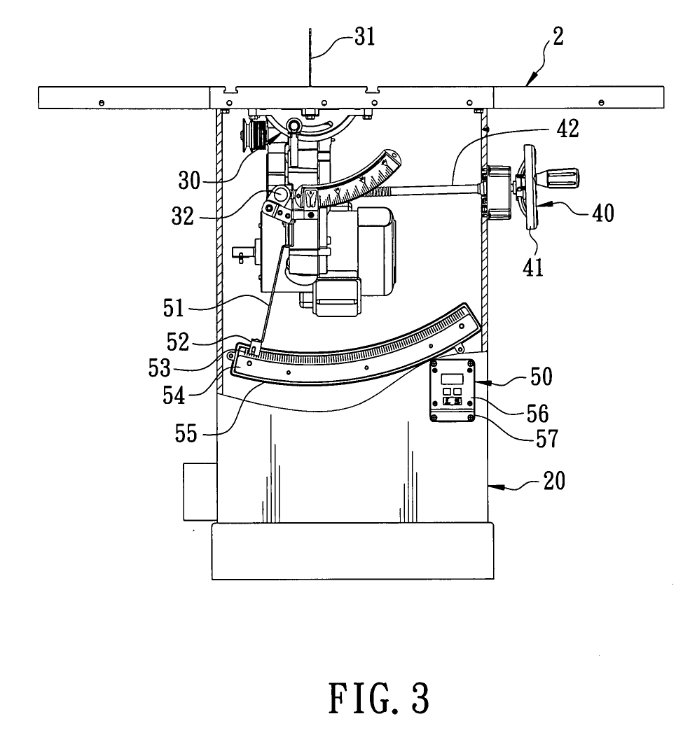

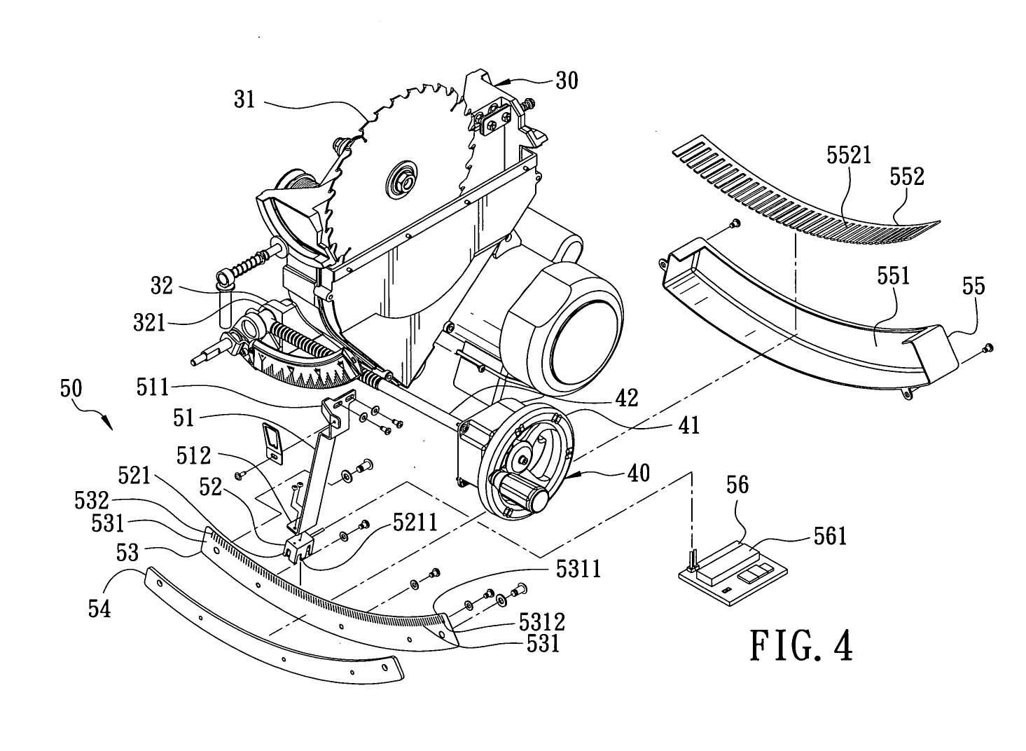

A first preferred embodiment of a sawing angle sensing device 50 for a sawing machine 2 in the present invention, as shown in FIGS. 2 to 5 is combined with the machine body 20 of a sawing machine 2, which further includes a saw base 30, a driving link 40 and angle. The saw base 30 and the driving link 40 are assembled in the machine body 20, and the saw base 30 is composed of a saw blade 31 and a rotatable base 32 for actuating the saw blade 31 to carry out cutting work. The driving link 40 has one end disposed with a turning wheel 41 and the other end fixed with a worm 42 threadably connected with the threaded hole 321 of the rotatable base 32 for actuating the rotatable base 32 to rotate. The turning wheel 41 can be freely turned at any angle for driving the worm 42 to rotate and actuate the rotatable base 32 and the saw blade 31 assembled on the rotatable base 32 to swing for a slant angle.

The angle-sensing device 50 is composed of a support frame 51, a sensing head 52, an induction plate 53, a reinforcing plate 54, a dust cover 55 and a display module 56.

The support frame 51 is shaped as an elongate plate having its upper side provided with a fixing end 511 having the same shape as one side of the rotatable base 32 so that the fixing end 511 can be secured on the rotatable base 32 for rotating and swinging together with the rotatable base 32 synchronously. The support frame 51 further has its lower side disposed with an L-shaped actuating end 512.

The sensing head 52 is positioned beneath the actuating end 512 of the support frame 51 to be actuated to swing by the support frame 51, having its lower front end provided with a sensing member 521 cut with a notch 5211 for carrying out sensing. In this preferred embodiment, the sensing head 52 is a kind of light sensor, such as an ultra-red ray sensor.

The induction plate 53 is fixed in the machine body 20 and positioned below the sensing head 52 to let the sensing head 52 fitted striding on the induction plate 53 with its upper edge locating in the notch 5211. The induction plate 53 is shaped as a curved plate having the upper portion of its surface provided with a plurality of induction members 531 arranged to make up a successive signal set 532. The induction members 531 are arranged in sequence according to the swinging path of the sensing head 52 to let the sensing head 52 able to always correspond to the induction members 531 and sense the shifting signals of the induction members 531. Further, the induction members 531 are respectively composed of a transparent member 5311 and an opaque member 5312 respectively shaped as a bar with an induction slot formed between the transparent member 5311 and the opaque member 5312.

The reinforcing plate 54 having the same shape as the induction plate 53 is locked at the lower portion of the induction plate 53 for strengthening the induction plate 53.

The dust cover 55 is formed with an upper open end 551 for receiving the induction plate 53 and the sensing head 52 therein. The open end 551 of the dust cover 55 is covered with a soft dust-preventing strip 552 made of rubber or plastic, or made of brush hair arranged together. The dust-preventing strip 552 is disposed with numerous insert slots 5521 preset in number and spaced apart equidistantly, and the support frame 51 is inserted through the insert slots 5521 to let the sensing head 52 swing under the dust-preventing strip 552.

The display module 56 is composed of a microchip set 561, a digital display 562 and a setting switch 563. The micro-chip set 561 functions to receive signals input by the sensing head 52 and have the signals collated and then output an angle tilt signal to the digital display 562, and after receiving the signal transmitted by the micro-chip set 561, the digital display 562 will indicate an angular value. The setting switch 563 is able to reset the measuring value of the angle-sensing device 50 to enable the angle-sensing device 50 to correct the measuring value anew.

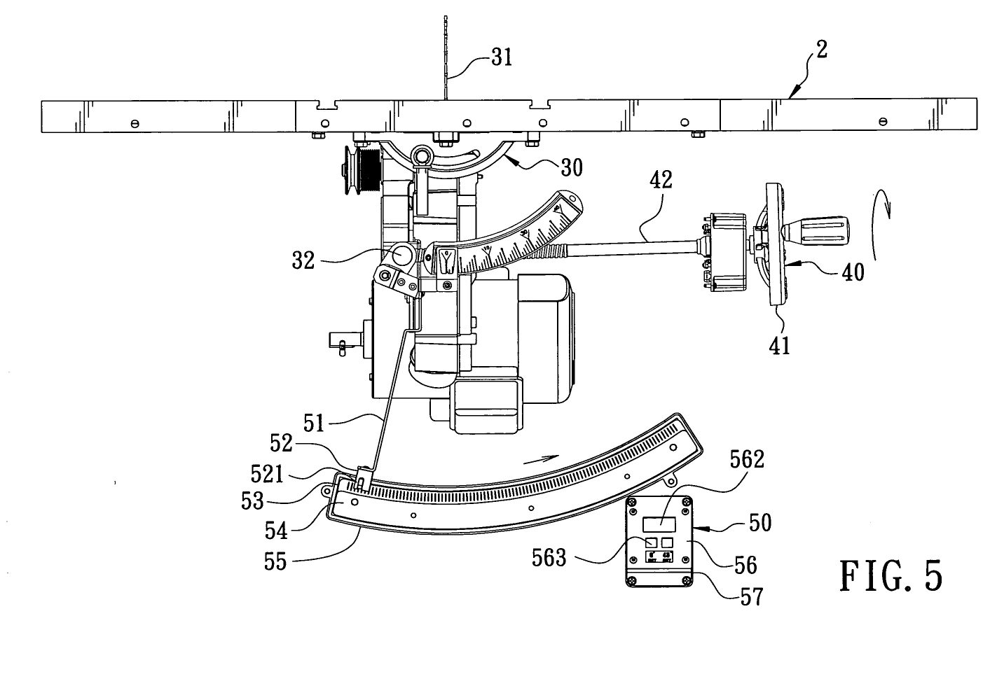

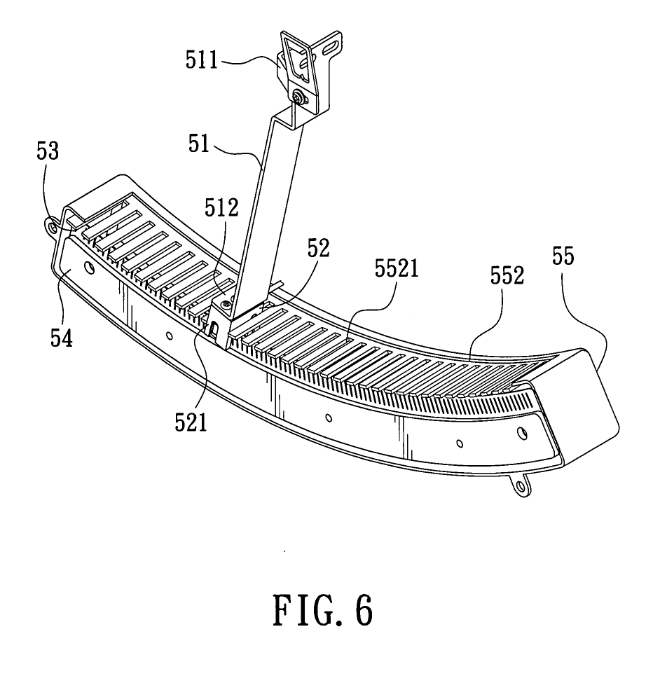

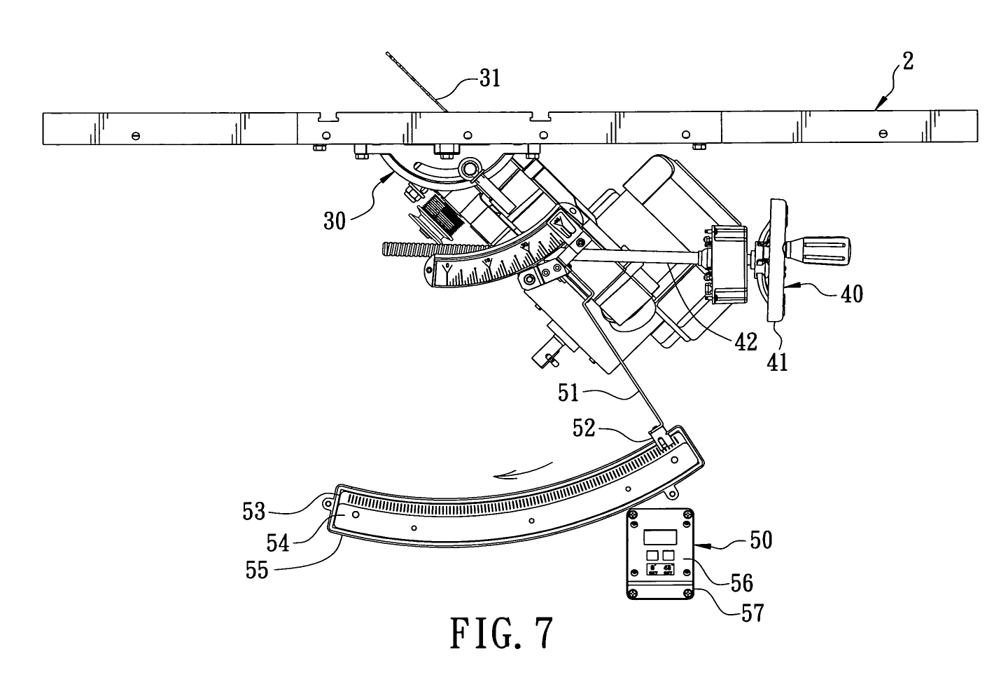

To adjust the angle of the saw base 30 of the sawing machine 2 of this invention, as shown in FIGS. 5, 6 and 7, firstly, the turning wheel 41 is turned to let the worm 42 drive the rotatable base 32 to rotate and actuate the saw base 30 to slant for an angle, and simultaneously the support frame 51 will swing together with the rotatable base 32 and actuate the sensing head 52 on the actuating end 512 to swing. At this time, since the indication members 531 are arranged in sequence with the swinging path of the sensing head 52, the sensing head 52 can all the time correspond to the induction members 531 and sense the shifting signal of the induction members 531. Synchronously, the shifting signal of the induction members 531 will be transmitted to the microchip set 561 of the display module 56 to be collated, and then the microchip set 561 will output an angle tilt signal to be shown on the digital display 562. So the setting switch 563 can be used to reset the measuring value of the angle sensing device 50 to let the angle sensing device 50 correct the measuring value anew to avoid producing errors. Substantially, the more the induction members 531 of the signal sets 532 on the induction plate 53 are formed, the more accurate the sensing signal offered by the signal sets 532 will be, and the more accurate the measuring value made by the angle sensing device 50 will become. In addition, the display module 56 is received in the interior of an external box 57 that is vertically assembled at the outer side of the machine body 20; therefore, a user can directly and easily read and adjust the angular value of the sawing machine 2.

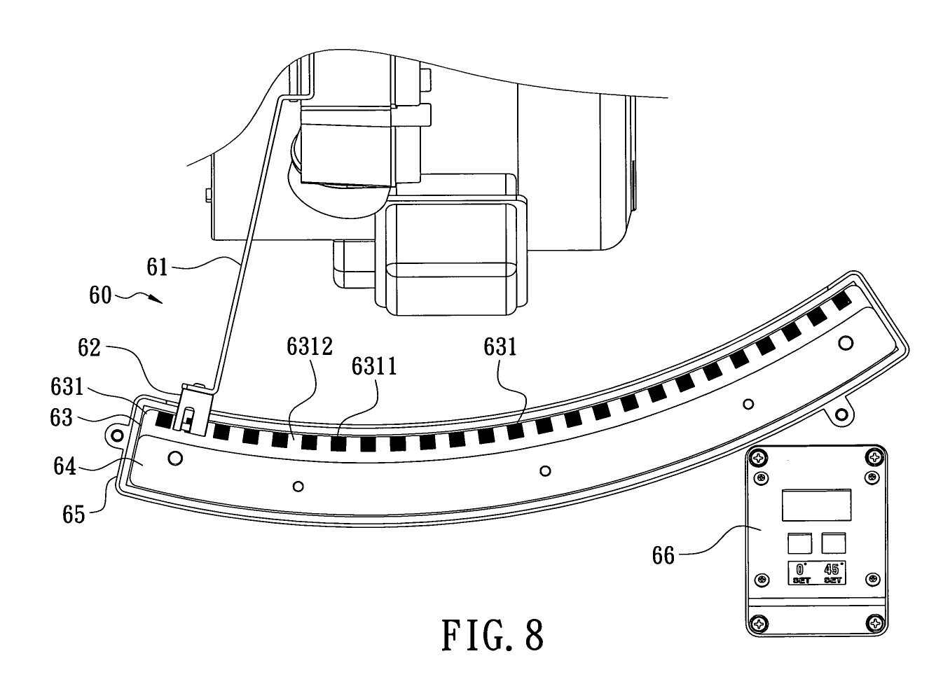

Referring to FIG. 8, a second preferred embodiment of a sawing angle sensing device 60 for a sawing machine in the present invention, having the same function as that described in the first preferred embodiment, includes a support frame 61, a sensing head 62, an induction plate 63, a reinforcing plate 64, a dust cover 65 and a display module 66. The sensing head 62 is a kind of magnetic sensing switch, and the induction members 631 on the induction plate 63 are respectively made of a magnetic member 6311 and a non-magnetic member 6312 positioned alternately. Thus, when the sensing head 62 approaches the induction members 631, the alternate magnetism between the induction members 631 will make the sensing head 62 produce a signal of the difference occurred between the two magnetisms.

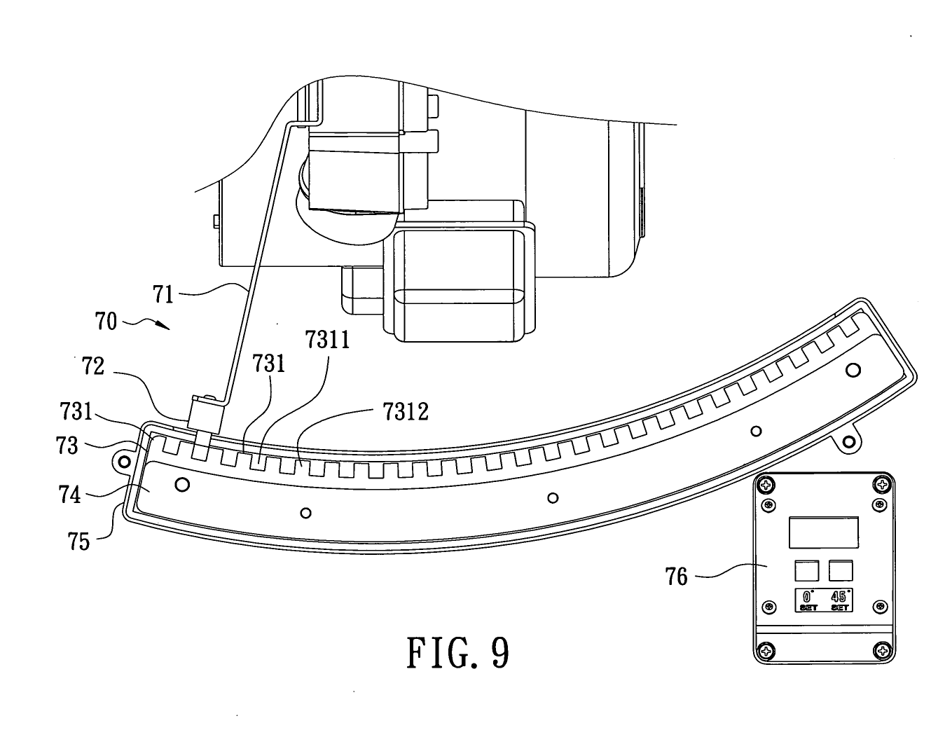

Referring to FIG. 9, a third preferred embodiment of a sawing angle sensing device for a sawing machine in the present invention, having the same function as that of the first preferred embodiment, is composed of a support frame 71, a sensing head 72, an induction plate 73, a reinforcing plate 74, a dust cover 75 and a display module 76. The sensing head 72 is a kind of proximate sensing switch, and the induction members 731 on the induction plate 73 are respectively made of a recess 7311 and a projection 7312. Thus, when the sensing head 72 approaches to the induction members 731, a pair of the recess 7311 and the projection 7312 of the induction member 731 will make the sensing head 72 produce a signal of distance difference.

As can be understood from the above description, this invention has the following advantages.

1. The angle of the saw base can directly be viewed through the digital display on the display module, needless to be measured with eyes, and able to avoid measuring errors and enhance measuring accuracy.

2. The measuring value of the angle sensing device can be repeatedly set and corrected by the setting switch; therefore, after being used for a period of time, the angle sensing device can still maintain its accuracy in measuring.

3. The display module is assembled at a location outside the sawing machine, where the angle signal of the saw base can easily and quickly be read, thus reducing adjustment time during processing.

While the preferred embodiments of the invention have been described above, it will be recognized and understood that various modifications may be made therein and the appended claims are intended to cover all such modifications that may fall within the spirit and scope of the invention.

I claim:

1. A sawing angle sensing device for a sawing machine, said sawing machine comprising a saw base and a driving link assembled in its interior, said driving link turned to drive a worm to rotate and actuate a rotatable base on said saw base to rotate and swing, said rotatable base rotated to actuate said saw base and the saw blade thereon to slant for an angle within a preset range, said angle sensing device composed of a support frame, a sensing head, an induction plate and a display module;
said support frame having one side fixing on said rotatable base for rotating and swinging together with said rotatable base synchronously;
said sensing head fixed at the other side of said support frame for swinging together with said support frame;
said induction plate assembled at a corresponding location of said sensing head and having the upper portion of its surface disposed with a successive signal set made of plural induction members, said induction members arranged in sequence with the swinging path of said sensing head, said sensing head corresponding to said induction members all the time for sensing the shifting signals of said induction members; and
said display module composed of at least a micro-chip set and a digital display, said micro-chip set receiving the signal input by said sensing head and having said signal collated, said micro-chip set then outputting an angle tilt signal to be shown on said digital display.

2. The sawing angle sensing device for a sawing machine as claimed in claim 1, wherein said support frame is shaped as elongate plate having its upper side provided with a fixing end preset in shape to be secured on said rotatable base for rotating and swinging together with said rotatable base synchronously, said support frame having its lower side provided with an L-shaped actuating end having its lower side secured with said sensing head, said support frame actuating said sensing head to swing.

3. The sawing angle sensing device for a sawing machine as claimed in claim 1, wherein said induction plate is shaped as a curved plate with a preset radian and has the upper portion of its surface disposed with a successive signal set made of numerous induction members, said induction plate having the lower portion of its surface fixed thereon with a reinforcing plate, which has the same shape as said induction plate.

4. The sawing angle sensing device for a sawing machine as claimed in claim 1, wherein said induction plate has one side covered with a dust cover having its upper side formed with an open end for receiving said induction plate and said sensing head therein, said upper open end of said dust cover covered thereon with a soft dust-preventing strip, said sensing head swinging under said dust-preventing strip.

5. The sawing angle sensing device for a sawing machine as claimed in claim 4, wherein said dust-preventing strip is made of rubber or plastic.

6. The sawing angle sensing device for a sawing machine as claimed in claim 4, wherein said dust-preventing strip is made of brush hair.

7. The sawing angle sensing device for a sawing machine as claimed in claim 1, wherein said sensing head is a kind of light sensor, and said induction members on said induction plate are respectively made of a transparent member and an opaque member.

8. The sawing angle sensing device for a sawing machine as claimed in claim 7, wherein said light sensor is a kind of ultrared-ray sensor.

9. The sawing angle sensing device for a sawing machine as claimed in claim 7, wherein said sensing head has its lower front end provided with a sensing member bored with a notch, and said sensing member is fitted striding said induction members on said induction plate, which has an upper edge fitting in said notch.

10. The sawing angle sensing device for a sawing machine as claimed in claim 1, wherein said sensing head is a kind of magnetic sensing switch, and said induction members on said induction plate are respectively made of a magnetic member and a non-magnetic member.

11. The sawing angle sensing device for a sawing machine as claimed in claim 1, wherein said sensing head is a kind of proximity sensing switch, and said induction members on said induction plate are respectively made of a recess and a projection.

12. The sawing angle sensing device for a sawing machine as claimed in claim 1, wherein the more induction members of the signal set on said induction plate are formed, the more accurate the sensing signals offered by said signal will be, and the more accurate the measuring value made by said angle sensing device will become.

13. The sawing angle sensing device for a sawing machine as claimed in claim 1, wherein said display module is provided with a setting switch for resetting the measuring value of said angle sensing device to let said angle sensing device correct said measuring value anew.
